(19) United States
(12) Patent Application Publication
(10) Pub. No.: US 2011/0240591 A1
(43) Pub. Date: Oct. 6, 2011

(54) METHOD OF MANUFACTURING IN-MOLD FORMING FILM WITH METAL SURFACE

(76) Inventor: Ching-Tu WANG, Taoyuan County (TW)

(21) Appl. No.: 12/873,457

(22) Filed: Sep. 1, 2010

(30) Foreign Application Priority Data
Apr. 1, 2010 (TW) 099110150

(51) Int. Cl. H01B 13/22

(52) U.S. Cl. 216/13

(57) ABSTRACT

A method of manufacturing an in-mold forming film with a metal surface provides a metal sheet layer having a coupling surface predetermining at least one etching area, and then applies an etching measure to the etching area at the coupling surface, such that recessed structures are formed inwardly on a surface of the etching area, and then injects a plastic material to the coupling surface of the metal sheet layer by an injection pressure after the metal sheet layer is etched, such that the plastic material is forced to cover the recessed structures in the etching area, and finally cures the plastic material to carry the metal sheet layer and form a tight connection relation between the cured plastic material and the recessed structures.

### FIELD OF THE INVENTION

The present invention relates to a method of manufacturing an in-mold forming (IMF) film, and more particularly to a method of manufacturing an in-mold forming film with a metal surface.

### BACKGROUND OF THE INVENTION

As electronic products tend to be smaller and lighter, various different portable products such as notebook computers, personal digital assistants, mobile phones, etc are introduced to the market to meet user requirements and used extensively by users. Besides the physical function of the electronic products, manufacturers also take the stylish design into account for the commercial purpose.

Traditional plastic products are limited by the plastic injection molding technology, and thus only a single-color injection molding lack of diversity can be achieved. If it is necessary to produce a plastic product with various patterns or colors, the patterns are coated onto a surface of a casing of the product by printing or spraying. Although a general printing process is a well-developed technology having the advantages of low cost and relatively easy manufacture, the printing ink coated onto the surface of the plastic product is in a direct contact with the outside, so that its color may be peeled off or worn out easily after a period of time, and the overall appearance of the product will be affected adversely. On the other hand, the spraying process requires repeated steps of covering the desired spraying area by a mask coating or a masking plate during the spray process before conducting the spraying, and the spraying method consumes much time and involves a complicated procedure, which are unfavorable for the mass production of the products. Furthermore, a conventional spraying process produces a large quantity of flying droplets containing lead or other heavy metals, not only wasting paints, but also contaminates the environment seriously. During the process of curing the paint or anti-scrape paint, a non-uniform surface thickness may result due to the difference of paints sprayed on different areas, particularly the area at a curved position where the paint is accumulated easily.

To overcome the aforementioned problems, manufacturers developed a series of in-mold decoration (IMD) processes including the in-mold roller (IMR), in-mold label (IML) and in-mold forming

(IMF) processes, wherein the IMR process prints an ink onto a plastic carrier film having a releasing capability, such that after a plastic material is injected to a plastic carrier film and combined with the ink, the carrier film is peeled off to transfer the ink to a surface of the shaped plastic finished product. On the other hand, the IML and IMF processes prepare a thin film first, and the thin film includes a curing layer printed with the ink, and a plastic layer covered onto the ink, such that the ink is included between the curing layer and the plastic layer, and after the thin film is attached onto the plastic finished product produced by the plastic injection molding, the process of peeling off the plastic carrier film adopted in the IMR process is no longer required.

Although the IMD process can provide a change of appearance for the electronic products to a certain extent, the overall appearance still shows the appearance of the plastic products. To offer a choice for an appearance other than the traditional plastic electronic products, manufacturers start electroplating, sputtering or hot-spraying the surface of an external plastic casing to produce a metal surface such as a cupper, nickel, aluminum or titanium alloy surface as disclosed in U.S. Pat. No. 6,045,866, R.O.C. Pat. Nos. 515751, M346244, and M334131, etc. Although the aforementioned prior arts can give a metal-like appearance to the surface of a conventional plastic casing, yet the coating on the surface may be peeled off or worn out easily, and the original plastic surface may be exposed. To enhance the metal surface of the products, manufacturers further developed a technology of coating a metal film onto the surface of a plastic casing directly as disclosed in R.O.C. Pat. Publication No. 200934371. The electronic device includes at least one electronic component and a casing. The casing includes a casing base layer and a metal film. The metal film is integrally formed with the casing base layer by the IMD process. The metal film also includes an adhesive layer for combining the casing base layer. However, this manufacturing method requires an adhesive layer between the metal film and the casing base layer. Since the metal film and the casing base layer are made of different materials, the choice of adhesive layer depends on a major factor whether or not the metal film can be coated securely onto the surface of the casing, and thus will incur a higher manufacturing cost.

### SUMMARY OF THE INVENTION

Therefore, it is a primary objective of the present invention to provide a metal-like appearance for an electronic product and improving the combining capability of attaching a metal surface onto a casing of the electronic product.

To achieve the foregoing objective, the present invention provides a method of manufacturing an in-mold forming film with a metal surface, and the method comprises the steps of

(a) providing a metal sheet layer which comprises at least one etching area predetermining a coupling surface;

(b) applying an etching measure to etch the etching area at the coupling surface for a first etching time, such that a plurality of recessed structures are formed inwardly on a surface of the etching area;

(c) injecting a plastic material onto the coupling surface of the metal sheet layer by an injection pressure, such that the injection pressure forces the plastic material to cover the recessed structures of the etching area; and

(d) curing the plastic material for carrying the metal sheet layer, such that a tight connection relation is formed between the cured plastic material and the recessed structures.

A step of forming a protective layer at non-etching area having the coupling surface takes place before the etching measure is applied, so that the position and shape of the protective layer can be used for determining the pattern and size of the etching area. A surface etching can be conducted to the etching area by the etching measure by applying a chemical solution or plasma selectively.

In another preferred embodiment of the present invention, the etching time is extended to increase the extent of etching the metal sheet layer. The process of applying the etching measure further takes place for a second etching time to etch the etching area completely, so as to form a hollow structure at the position of the etching area and on the metal sheet layer. The hollow structure includes an antenna module which can be a wireless communication protocol module, a Bluetooth transmission module or a radio frequency transmission module.

With the method of manufacturing an in-mold forming film with a metal surface in accordance with the present invention, the metal material may be applied in the IMD technology, such that the electronic product can show a metal-like appearance. In addition, the plurality of recessed structures of the metal sheet layer etched in the etching area can be combined tightly with the plastic material injected by the IMD process. Therefore, the manufacturing method can omit the adhesive layer and achieve a more secured connection than the adhesive layer, so as to achieve the effects of simplifying manufacturing process and reducing production costs.

### BRIEF DESCRIPTION OF THE DRAWINGS

FIG. 1 is a flow chart of a method of manufacturing an in-mold forming film with a metal surface in accordance with a preferred embodiment of the present invention;

FIGS. 2A to 2F are processing schematic views showing the steps of a method of manufacturing an in-mold forming film with a metal surface in accordance with a preferred embodiment of the present invention;

FIG. 3 is a cross-sectional view of a metal sheet layer used in a method of manufacturing an in-mold forming film with a metal surface in accordance with another preferred embodiment of the present invention;

FIG. 4 is a cross-sectional view of a product manufactured by a method of manufacturing an in-mold forming film with a metal surface in accordance with another preferred embodiment of the present invention; and

FIG. 5 is a perspective view of a product manufactured by a method of manufacturing an in-mold forming film with a metal surface in accordance with another preferred embodiment of the present invention.

### DETAILED DESCRIPTION OF THE PREFERRED EMBODIMENTS

The technical contents of the invention will now be described in more detail hereinafter with reference to the accompanying drawings that show various embodiments of the invention.

The present invention is applicable for various different in-mold decoration (IMD) processes, including the in-mold roller (IMR) process, in-mold label (IML) process and in-mold forming (IMF) process, particularly the IMR process.

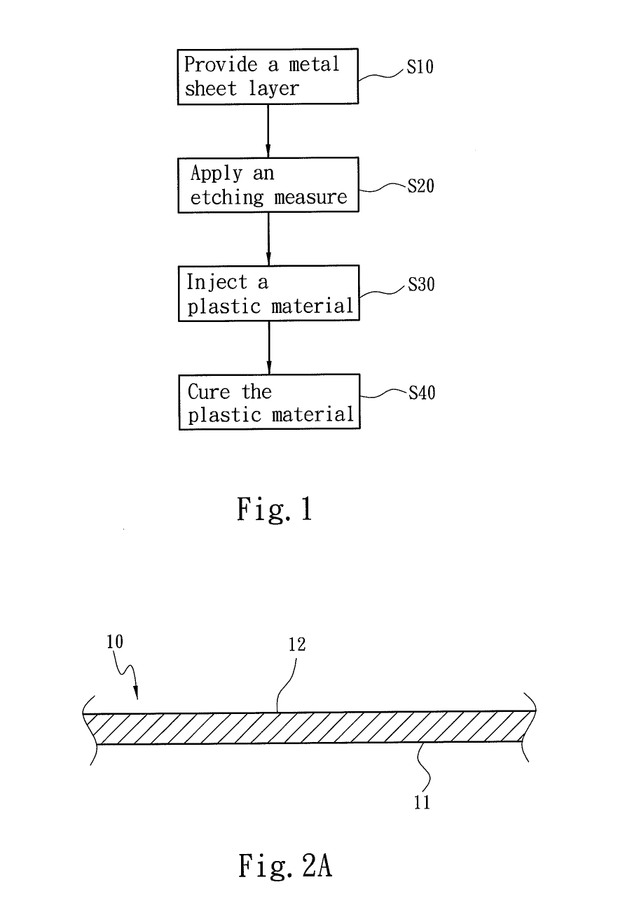

With reference to FIG. 1 for a flow chart of a preferred embodiment of the present invention, a method of manufacturing an in-mold forming film with a metal surface disclosed by the present invention comprises the steps of:

providing a metal sheet layer (S10) comprising a coupling surface predetermining at least one etching area;

applying an etching measure (S20) to etch the etching area of the coupling surface for a first etching time, such that a plurality of recessed structures are formed inwardly on a surface of the etching area;

injecting a plastic material (S30) onto the coupling surface of the metal sheet layer by an injection pressure, such that the injection pressure forces the plastic material to cover the recessed structures of the etching area; and

curing the plastic material (S40) for carrying the metal sheet layer, such that a tight connection relation is formed between the cured plastic material and the recessed structures.

In Step (S20), the etching measure performs an etch to the etching area of the coupling surface, or a protective layer is formed on the non-etching area of the coupling surface before Step (S20) takes place, and then the etching measure is applied to the etching area.

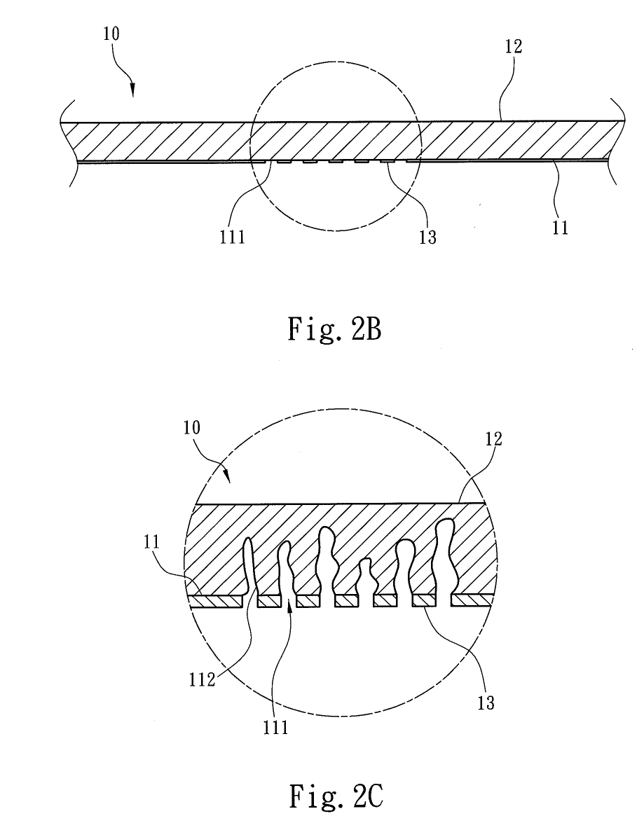

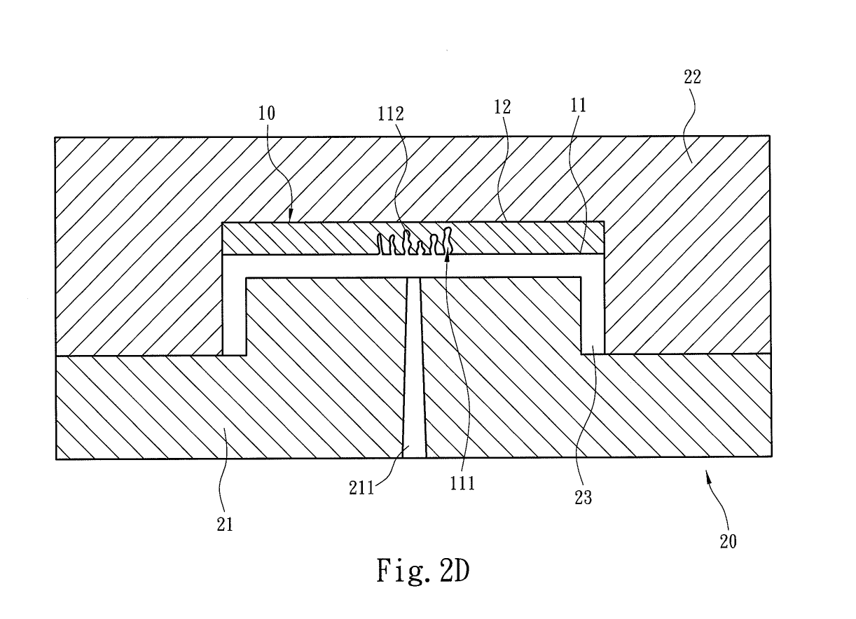

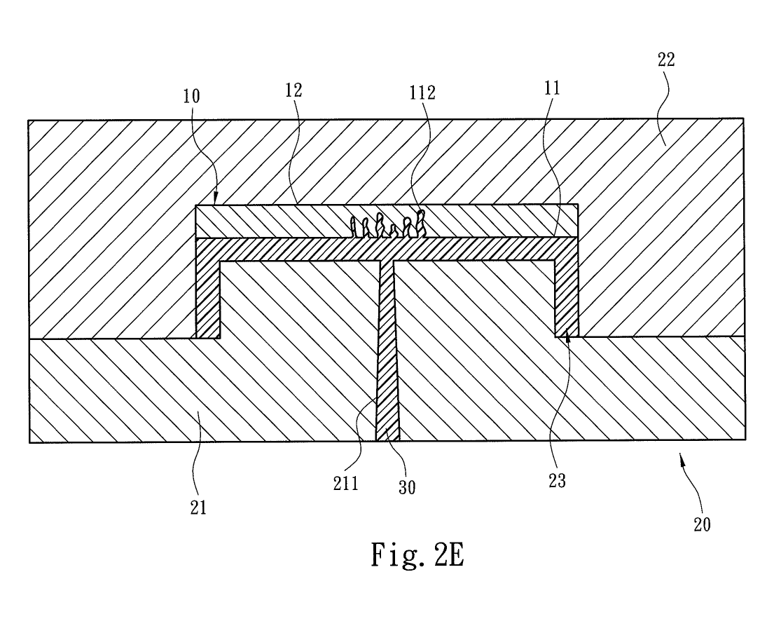

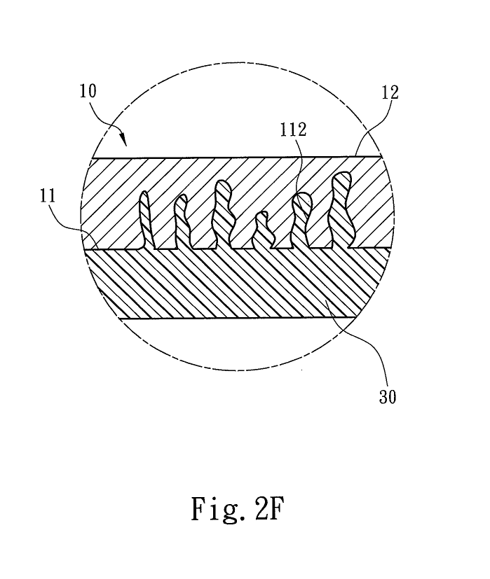

With reference to FIGS. 2A to 2F for schematic views showing the steps of a method of manufacturing a decoration film in accordance with the foregoing preferred embodiment of the present invention, a metal sheet layer 10 is prepared, wherein the metal sheet layer 10 can be made of a material such as steel, iron, stainless steel, titanium alloy, aluminum alloy, magnesium alloy, nickel alloy or zinc alloy. The metal sheet layer 10 includes a coupling surface 11 and a decoration surface 12 as shown in FIG. 2A. The coupling surface 11 predetermines at least one etching area 111 disposed thereon and a protective layer 13 disposed on the coupling surface 11 and at a position other than the etching area 111. The protective layer 13 is formed on the coupling surface 11 of the metal sheet layer 10 by a surface printing method as shown in FIG. 2B.

The coupling surface 11 is etched, and the metal sheet layer 10 having the protective layer 13 is dipped into an etching solution. The metal sheet layer 10 without a protective layer 13, i.e. the etching area 111 of the coupling surface 11, is chemically reacted with the etching solution. After a first etching time, the etching area 111 is recessed inwardly towards the surface of the metal sheet layer 10 to form a plurality of recessed structures 112 as shown in FIG. 2C. To stop the etching solution from continuing etching the metal sheet layer 10, the etching solution attached onto the metal sheet layer 10 and the protective layer 13 are removed after the etching process is completed, such that the chemical etching reaction will end. In the present invention, the etching is not limited to the method used in the preferred embodiment only, but a wet etching method or a plasma etching method which is a dry etching method can be used instead.

The etched metal sheet layer 10 is placed into an IMD mold 20. The IMD mold 20 includes a male mold portion 21 having an injection gate 211 and a female mold portion 22 for holding the metal sheet layer 10. In FIG. 2D, the male mold portion 21 and the female mold portion 22 are combined to form a shaping chamber 23, and the shaping chamber 23 is connected to the injection gate 211. In FIG. 2E, the injection gate 211 is provided for injecting a plastic material 30 to the coupling surface of the metal sheet layer 10 by an injection pressure and filling the plastic material 30 into the shaping chamber 23. The plastic material 30 can be a metal or a plastic material. The metal material can be aluminum, magnesium, zinc or their alloys, etc. The plastic material can be polyethylene terephthalate (PET), acrylonitrile butadiene styrene (ABS), polycarbonate (PC), polyvinyl chloride (PVC) or polypropylene (PP), etc. The plastic material 30 is forced into the etching area 111 of the coupling surface 11 by the injection pressure and covered onto the etched recessed structures 112. After the plastic material 30 is cured, a tight connection relation is formed between the plastic material 30 and the recessed structures 112 as shown in FIG. 2F.

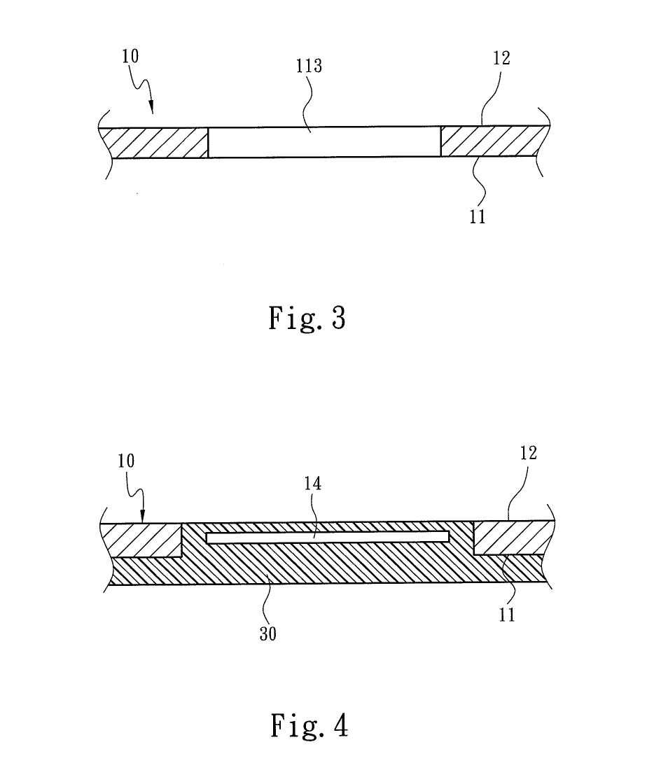

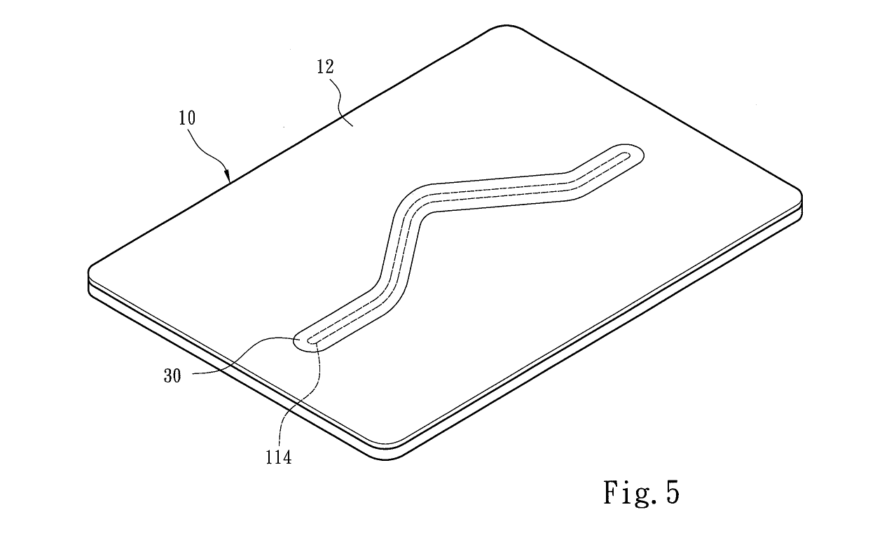

In another preferred embodiment of the present invention, the etching is preformed for a second etching time to etch the metal sheet layer 10 in the etching area 111 completely, in addition to the first etching time for forming the recessed structures 112, if the coupling surface 11 of the etching area 111 is chemically reacted with the etching solution. After the second etching time, a hollow structure 113 is formed on the metal sheet layer 10 and at the position of the etching area 111 as shown in FIG. 3. The hollow area 113 includes an antenna module 14 therein. The aforementioned IMD process is repeated, such that the plastic material 30 is filled into the hollow area 113, and the antenna module 14 is fixed at a position inside the hollow area 113 as shown in FIGS. 4 and 5. The antenna module 14 can be a wireless communication protocol module, a Bluetooth transmission module or a radio frequency transmission module, etc.

In summation of the description above, the method of manufacturing an in-mold forming film with a metal surface in accordance with the present invention provides a metal-like appearance to the surface of electronic products and omits the adhesive layer between the metal sheet layer and the plastic material to save the production cost and simplify the manufacturing process. Obviously, the present invention improves over the prior art and complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A method of manufacturing an in-mold forming film with a metal surface, comprising the steps of:
providing a metal sheet layer which comprising a coupling surface predetermining at least one etching area;
applying an etching measure to the etching area of the coupling surface for a first etching time, such that a plurality of recessed structures are formed inwardly on a surface of the etching area;
injecting a plastic material to the coupling surface of the metal sheet layer by an injection pressure, such that the plastic material is forced by the injection pressure to cover the recessed structures of the etching area; and
curing the plastic material to carry the metal sheet layer, wherein a tight connection relation is formed between the cured plastic material and the recessed structures.

2. The method of manufacturing an in-mold forming film with a metal surface according to claim 1, further comprising a step of forming a protective layer on a non-etching area of the coupling surface before applying an etching measure to the etching area.

3. The method of manufacturing an in-mold forming film with a metal surface according to claim 1, further comprising a step of removing the etching measure after applying an etching measure to the etching area.

4. The method of manufacturing an in-mold forming film with a metal surface according to claim 1, wherein the etching measure performs a surface etching by applying a chemical solution to the etching area.

5. The method of manufacturing an in-mold forming film with a metal surface according to claim 1, wherein the etching measure performs a surface etching by applying plasma to the etching area.

6. The method of manufacturing an in-mold forming film with a metal surface according to claim 1, wherein the step of applying an etching measure further takes place for a second etching time, such that the etching area is etched completely to form a hollow structure on the metal sheet layer and at a position of the etching area.

7. The method of manufacturing an in-mold forming film with a metal surface according to claim 6, wherein the hollow structure includes an antenna module disposed therein.

8. The method of manufacturing an in-mold forming film with a metal surface according to claim 7, wherein the antenna module is selected from the group consisting of a wireless communication protocol module, a Bluetooth transmission module, and a radio frequency transmission module.

9. The method of manufacturing an in-mold forming film with a metal surface according to claim 1, wherein the metal sheet layer is made of a material selected from the group consisting of steel, iron, stainless steel, titanium alloy, aluminum alloy, magnesium alloy, nickel alloy and zinc alloy.
